(19) United States
(12) Patent Application Publication
(10) Pub. No.: US 2025/0365047 A1
(43) Pub. Date: Nov. 27, 2025

(54) METHOD AND APPARATUS FOR BEAM MANAGEMENT USING MULTI-MODAL SENSING

(71) Applicants: Samsung Electronics Co., Ltd., Gyeonggi-do (KR); Seoul National University R&DB Foundation, Seoul (KR)

(72) Inventors: Jeonghyeon JANG, Gyeonggi-do (KR); Byonghyo SHIM, Seoul (KR); Hyunsoo KIM, Seoul (KR)

(21) Appl. No.: 19/219,170

(22) Filed: May 27, 2025

(30) Foreign Application Priority Data
May 27, 2024 (KR) 10-2024-0068900

(51) Int. Cl. H04B 7/06; G01S 17/86

(52) U.S. Cl. CPC H04B 7/0617; G01S 17/86

(57) ABSTRACT

The disclosure relates to a 5G or 6G communication system for supporting higher data rates compared to a 4G communication system such as LTE. A method of a BS in a wireless communication system includes obtaining cloud point information through a LiDAR sensor, obtaining image information through a camera, extracting a region of interest based on the cloud point information; projecting the region of interest onto the image information, identifying an image of a terminal within the region of interest projected onto the image information, calculating three-dimensional location information for the terminal, and performing beamforming based on the three-dimensional location information.

### CROSS-REFERENCE TO RELATED APPLICATION(S)

This application is based on and claims priority under 35 U.S.C. § 119 to Korean Patent Application No. 10-2024-0068900, which was filed in the Korean Intellectual Property Office on May 27, 2024, the entire disclosure of which is incorporated herein by reference.

### BACKGROUND

### 1. Field

The disclosure relates generally to a method and apparatus for performing beam management (BM) using multi-modal sensing and, more particularly, to a method and apparatus for improving accuracy and computational efficiency of beamforming.

### 2. Description of Related Art

Following the commercialization of 5th-generation (5G) communication systems, it is expected that the number of devices that will be connected to communication networks will exponentially grow. Examples of connected devices may include vehicles, robots, drones, home appliances, displays, smart sensors connected to various infrastructures, construction machines, and factory equipment.

Mobile devices are also expected to evolve in various form-factors, such as augmented reality glasses, virtual reality headsets, and hologram devices.

In order to provide various services by connecting hundreds of billions of devices and things in a 6th-generation (6G) era, there are ongoing efforts to develop improved 6G communication systems (or beyond-5G systems).

6G communication systems, which are expected to be commercialized around 2030, should have a peak data rate of tera (1,000 giga)-level bits per second (bps) and a radio latency less than 100 μsec, and thus should be 50 times as fast as 5G communication systems and have the 1/10 radio latency thereof.

In order to accomplish such a high data rate and an ultra-low latency, 6G communication systems is being developed for implementation in a terahertz (THz) band (e.g., 95 GHz to 3 THz bands). It is expected that, due to severer path loss and atmospheric absorption in the THz bands than those in mmWave bands introduced in 5G, technologies capable of securing the signal transmission distance (that is, coverage) will become more crucial.

Accordingly, to secure the coverage, various technologies such as radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas are being developed. In addition, there are ongoing discussion on new technologies for improving the coverage of THz band signals, such as metamaterial-based lenses and antennas, orbital angular momentum (OAM), and reconfigurable intelligent surface (RIS).

To improve the spectral efficiency and the overall network performance, the following technologies have been developed for 6G communication systems: a full-duplex technology for an uplink (UL) transmission and a downlink (DL) transmission to simultaneously use the same frequency resources; a network technology for utilizing satellites, high-altitude platform stations (HAPS), and the like in an integrated manner; an improved network structure for supporting mobile base stations (BSs) and the like and allowing network operation optimization and automation and the like; a dynamic spectrum sharing technology via collision avoidance based on a prediction of spectrum usage; a use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, etc.) over the network.

In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Recently, millimeter wave (mmWave) band communication has attracted much attention as a key technology supporting applications with high data traffic and ultra-low latency. By leveraging abundant frequency spectrum resources of the mmWave band (e.g., 30 to 300 GHz), mmWave communication can support truly immersive services such as digital twins, metaverses realized by XR devices, and high-definition mobile holographic displays. However, a drawback of mmWave communication is the severe attenuation of signal power due to propagation, reflection, diffuse scattering, and atmospheric absorption losses. To address this, a narrow-width, sharp beamforming technique (ultra sharp beamforming or pencil beamforming) using ultra massive MIMO (UM-MIMO) may be utilized. However, this is also problematic in that it results in a relatively large amount of beam training overhead.

In 5G new radio (NR), a codebook-based BM technique has been introduced to increase the capacity of the system. The 5G NR BM technique is composed of 1) a beam sweeping process in which the BS sequentially transmits beams selected from beam codewords to determine the approximate location of the terminal, and 2) a beam refinement process in which a narrower beam is selected based on the estimated location. Specifically, in the beam sweeping process, the BS sequentially transmits synchronization signal blocks (SSBs) to the terminal by using a 2-dimensional (2D)-discrete Fourier transform (DFT)-based codebook, and the terminal feeds back the index of the beam in the direction where the strength of the received signal is maximized to the BS. In the beam refinement process, the BS may select the optimal beam by transmitting multiple channel state information (CSI)-reference signal (RSs) based on the approximate direction of the terminal obtained from beam sweeping and receiving the corresponding measurement results from the terminal.

Existing codebook-based BM techniques are effective in relatively low frequency bands (e.g., long term evolution (LTE) or 5G NR frequency range 1 (FR1)), but there are problems in the mmWave band. One problem is beam misalignment due to a finite number of beam codewords. More specifically, in mmWave communication, there is a difference between a beam direction and an actual terminal direction due to strong straightness, which causes beamforming gain to deteriorate. For example, when an oversampling ratio is 4 in an 8×8 planar array antenna, i.e., 32×32 beams are used, the worst case beam error is approximately 40, which may cause a 20% beamforming gain degradation.

Another problem is the relatively large amount of pilot overhead between the BS and the terminal. For example, when transmitting 4 CSI-RSs in a 5G NR beam refinement process for the mmWave band, delay time is approximately 30 ms. This is much longer than a coherence time of 9 ms when the terminal moves at 30 km/h, so the beam direction and the actual terminal direction may be misaligned.

Therefore, a need exists for new BM techniques that can accurately form a beam toward the terminal with low pilot overhead.

### SUMMARY

An aspect of the disclosure is to provide a multi-modal communication technique to support beam focusing of 6G mmWave systems.

Another aspect of the disclosure is to provide a technique for multi-modal sensing-aided BM (MMBM), which synthetically utilizes sensing information obtained from multiple sensors (e.g., red, green, blue (RGB) camera and light detection and ranging (LiDAR)) to generate beam focusing vectors. THz band signals with high frequencies have physical characteristics close to visible light (e.g., 400 to 790 THz), so most of the transmission energy is concentrated on the line-of-sight (LoS) path. By utilizing this point, the MMBM method may extract location information of a mobile device from the sensing information and then generate a focus beam directed in the direction of the extracted location.

In accordance with an aspect of the disclosure, a method performed by a BS in a wireless communication system includes obtaining cloud point information through a LiDAR sensor, obtaining image information through a camera, extracting a region of interest based on the cloud point information, projecting the region of interest onto the image information, identifying an image for a terminal within the region of interest projected onto the image information, calculating three-dimensional location information for the terminal, and performing beamforming based on the three-dimensional location information.

In accordance with another aspect of the disclosure, a BS in a wireless communication system includes a transceiver; and a controller configured to obtain cloud point information through a LiDAR sensor, obtain image information through a camera, extract a region of interest based on the cloud point information, project the region of interest onto the image information, identify an image of a terminal within the region of interest projected onto the image information, calculate three-dimensional location information for the terminal, and perform beamforming based on the three-dimensional location information.

According to embodiments of the disclosure, in a UM-MIMO environment with a relatively large number of antenna elements, a beam can be accurately formed toward a terminal with low pilot overhead by estimating an exact location of the terminal by using sensor equipment and AI-based technology.

In addition, terminal detection accuracy can be significantly improved by introducing LiDAR region-of-interest (LRoI) extraction to the process of extracting terminal location information from sensing information, and the terminal location can be effectively extracted by using a deep neural network-based object detector (OD).

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a beam generation method according to an embodiment;

FIG. 2 illustrates a disadvantage of performing object detection through single-modal sensing-aided BM (SMBM);

FIG. 3 illustrates a method utilizing MMBM according to an embodiment;

FIG. 4 illustrates a method utilizing MMBM according to an embodiment;

FIG. 5 illustrates a method for performing LRoI extraction according to an embodiment;

FIG. 6 illustrates a method for performing CV-based geometric channel information extraction according to an embodiment;

FIG. 7 illustrates a scenario for MMBM operations according to an embodiment;

FIG. 8 illustrates a method for performing UE-side beamforming according to an embodiment;

FIG. 9 illustrates experiment results according to an embodiment;

FIG. 10 illustrates experiment results according to an embodiment;

FIG. 11 illustrates a terminal according to an embodiment;

FIG. 12 illustrates a BS according to an embodiment; and

FIG. 13 illustrates a network entity according to an embodiment.

### DETAILED DESCRIPTION

Hereinafter, various embodiments of the disclosure will be described in detail with reference to the accompanying drawings.

In describing the embodiments, descriptions related to technical contents that are well-known in the art and/or are not associated directly with the disclosure will be omitted. Such an omission of unnecessary descriptions is intended to prevent obscuring of the main idea of the disclosure and more clearly transfer the main idea.

In the accompanying drawings, some elements may be exaggerated, omitted, or schematically illustrated. Further, the size of each element does not completely reflect the actual size. In the drawings, identical or corresponding elements may be provided with identical or similar reference numerals.

Various advantages and features of the disclosure and ways to achieve them will be apparent by making reference to embodiments as described below in detail in conjunction with the accompanying drawings. However, the disclosure is not limited to the embodiments set forth below, but may be implemented in various different forms.

The embodiments described herein are provided only to completely disclose the disclosure and inform those skilled in the art of the scope of the disclosure, and the disclosure is defined only by the scope of the appended claims.

The terms utilized in the description below are terms defined in consideration of the functions in the disclosure, and may be different according to users, intentions of the operators, or customs. Therefore, the definitions of the terms should be made based on the contents throughout the specification.

Herein, each block of the flowchart illustrations, and combinations of blocks in the flowchart illustrations, may be performed based on computer program instructions. These computer program instructions may be loaded collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). In some alternative implementations, the functions noted in the blocks may occur out of the order. For example, two blocks (or functions) shown in succession may in fact be performed substantially concurrently or the blocks may sometimes be performed in the reverse order, depending upon the functionality involved.

As used herein, a “˜unit” may refer to a software element or a hardware element, such as a field programmable gate array (FPGA) or an application specific integrated circuit (ASIC), which performs a predetermined function. However, the term including the word “˜unit” does not always have a meaning limited to software or hardware. The “˜unit” may be constructed either to be stored in an addressable storage medium or to execute one or more processors. Therefore, the “˜unit” may include, for example, software elements, object-oriented software elements, components such as class elements and task elements, processes, functions, properties, procedures, sub-routines, segments of a program code, drivers, firmware, micro-codes, circuits, data, database, data structures, tables, arrays, and/or parameters. The components and functions provided by the “˜unit” may be either combined into a smaller number of components and a “˜unit,” or divided into additional components and a “˜unit.” Moreover, the components and “˜units” may be implemented to reproduce one or more central processing units (CPUs) within a device or a security multimedia card. Further, a “˜unit” may include one or more processors.

The blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The processor or combination of processors may include circuitry performing processing such as an application processor (AP), e.g. a CPU, a communication processor (CP), e.g., a modem, a graphics processing unit (GPU), a neural processing unit (NPU), e.g., an AI chip, a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio codec chip, a universal serial bus (USB) controller, a camera controller, an image processing IC, a microprocessor unit (MPU), a system on chip (SoC), an IC, etc.

Various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, e.g., random access memory (RAM), memory chips, device or ICs or on an optically or magnetically readable medium such as, e.g., a compact disc (CD), digital versatile disc (DVD), magnetic disk, magnetic tape, etc. The storage devices and storage media are various embodiments of non-transitory machine-readable storage that are suitable for storing a computer program or computer programs comprising instructions that, when executed, implement various embodiments of the disclosure. Accordingly, various embodiments of the present disclosure may provide a program comprising code for implementing apparatus or a method as claimed in any one of the claims of this specification and a non-transitory machine-readable storage storing such a program.

Hereinafter, a determination of priority between A and B may refer to various actions such as selecting the one having a higher priority based on a predefined priority rule and performing an operation corresponding thereto, or omitting or dropping an operation corresponding to the one having a lower priority.

“A or B” as described in the present disclosure may be understood as “A and/or B,” which may include A, or B, or both A and B. In addition, “at least one of A, B, or C” as described in the present disclosure may be understood to include A, B, or C, or any combination of A, B, and C.

Furthermore, “A/B,” “A, B” or “A and B” as described in the present disclosure may be understood as “A and/or B,” which may include A, B, or A and B.

Furthermore, the terms “first˜”, “second˜”, etc., as described in the present disclosure with respect to various elements (e.g., information, objects, operation, sequences, etc.), do not limit those elements. These terms are only intended to distinguish one element from another, and may not be intended to indicate a specific order. For example, a first element could be termed a second element, and, similarly, a second element could be termed a first element.

In addition, phrases such as “transmitting a message including A and B”, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, and/or C), transmitted either together or separately.

Similarly, “transmitting a message including A and transmitting a message including B” may also be interpreted as transmitting a message including A and B in a single message.

In the specific embodiments of the present disclosure described below, terms or components included in the disclosure may be expressed in singular or plural form depending on the specific embodiments presented. However, such singular or plural expressions are selected appropriately for convenience of description, and the present disclosure is not limited to a singular or plural number of components. A component expressed in the plural form may be implemented as a single component, and a component expressed in the singular form may be implemented as multiple components.

The drawings or flowcharts described below illustrate exemplary methods that may be implemented according to the principles of the present disclosure, and various modifications may be made to the methods illustrated in the flowcharts of the present disclosure. For example, although illustrated as a series of steps, various steps in each drawing or flowchart may overlap, occur in parallel, occur in a different order, or be repeated. In other examples, any step may be omitted or replaced with another step.

The methods and apparatuses proposed in the embodiments of the present disclosure are not limited to each embodiment individually, but may also be applied in combination of all or some of the embodiments proposed in the disclosure. Therefore, the embodiments of the present disclosure may be modified and applied without significantly departing from the scope of the present disclosure, as would be understood by those skilled in the art.

Even if certain wordings are described differently across embodiments, they may be used interchangeably or in substitution or in combination if their underlying concepts are equivalent. For example, for the same or equivalent concept, even if one embodiment uses the expression “A” and another embodiment uses the expression “B”, such expressions may be understood interchangeably, in substitution, or in combination.

The terms used in the following description to refer to access nodes, network entities, messages, interfaces between network entities, various types of identification information, etc., are provided merely for the convenience of explanation by way of example. Therefore, the present disclosure is not limited to the terms described below, and other terms having equivalent technical meanings may also be used. Such terms may also be interchangeable with terms defined in any 3rd generation partnership project (3GPP) technical specifications (TS) where appropriate.

Hereinafter, a BS is an entity that allocates resources to terminals, and may include a gNode B, an eNode B, a Node B, a wireless access unit, a BS controller, or a node on a network. Furthermore, the BS may include a split architecture including a central unit (CU) and a distributed unit (DU), wherein the CU is configured to process higher layers of control and user planes, and the DU is configured to process lower-layer radio resource functions. Embodiments of the disclosure may be equally applicable to 5G BS architectures in which such CU and DU functional splits are implemented.

A terminal may include a UE, a mobile station (MS), a cellular phone, a smartphone, a computer, or a multimedia system capable of performing communication functions.

Herein, a DL refers to a radio link through which a BS transmits a signal to a UE, and a UL refers to a radio link through which a UE transmits a signal to a BS.

Hereinafter, 5G mobile communication technologies (e.g., 5G NR) and 6G mobile communication technologies may be described by way of example, but the embodiments of the present disclosure may also be applied to other communication systems having similar technical backgrounds or channel types. For example, newly evolved mobile communication systems developed after 5G and 6G may be included. Furthermore, based on determinations by those skilled in the art, the embodiments of the present disclosure may also be applied to other communication systems (e.g., Wi-Fi systems) through some modifications without significantly departing from the scope of the present disclosure.

In the following description, the terms physical channel and signal may be used interchangeably with data or control signal. For example, the term physical DL shared channel (PDSCH) refers to a physical channel through which data is transmitted, but the term PDSCH may also be used to refer to the data itself. That is, in the present disclosure, the expression “transmit a physical channel” may be interpreted as being equivalent to the expression “transmit data or a signal via a physical channel.”

Hereinafter, higher layer signaling may refer to signaling corresponding to at least one or any combination of the following: a master information block (MIB), a system information block (SIB) or SIB X (X=1, 2, . . . ), radio resource control (RRC), a medium access control (MAC) control element (CE), a non-access stratum (NAS) signaling message, or an application layer message. The RRC signaling message may also be referred to as layer 3 (L3) signaling.

In addition, layer 1 (L1) (or physical layer) signaling may refer to signaling corresponding to at least one or any combination of signaling techniques using the at least one or any combination of the following physical layer channels or signaling: physical DL control channel (PDCCH), DL control information (DCI), user equipment (UE)-specific DCI, group-common DCI, common DCI, scheduling DCI (e.g., DCI used for scheduling DL or UL data), non-scheduling DCI (e.g., DCI not used for scheduling DL or UL data) physical UL control channel (PUCCH), or UL control information (UCI).

The expression that information is configured by the BS, as used in the present disclosure or claims, may, in context, be understood to mean that the terminal receives the corresponding information from the BS via a physical layer signaling or a higher layer signaling. Such an expression may be replaced with other terms having the same or substantially equivalent meaning.

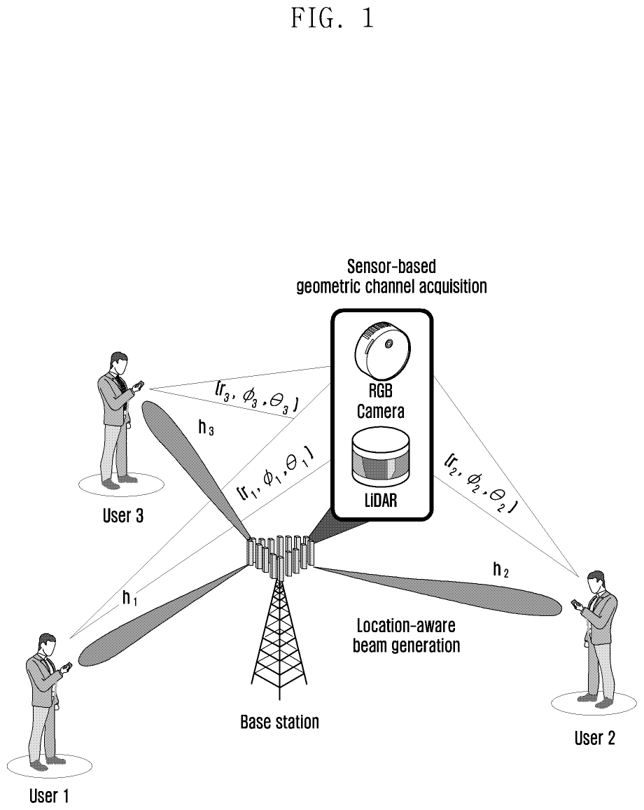

FIG. 1 illustrates a beam generation method according to an embodiment. More specifically, FIG. 1 illustrates a method of identifying exact location information of UEs using a LiDAR sensor and a camera (e.g., an RGB camera sensor), and performing beamforming based on location information identified by a BS.

Referring to FIG. 1, in relation to a plurality of users, i.e., Users 1, 2, and 3, the BS may perform communication with a UE carried by each user. When communicating with a UE, the BS may perform directional communication to improve communication quality, which may be referred to as beamforming.

In 5G NR, a single BS may form multiple beams and focus signals in a specific direction depending on a user's location, which can improve signal quality (e.g., signal-to-interference-plus-noise ratio (SINR)) and improve communication speed and coverage. However, when performing communication utilizing a beamforming technique, continuous BM may be required to readjust the beam due to movement of the user or the appearance of an obstacle.

The functions to perform BM may be configured by including at least the following functions.
Beam sweeping: an operation to search for an optimal direction while transmitting or receiving beams in various directions.
Beam measurement: an operation to measure various qualities of beams (e.g., RS received power (RSRP), signal-to-noise ratio (SNR), etc.).
Beam determination: an operation to determine an optimal beam based on beam measurement results.
Beam switching: an operation to switch a beam currently in use to another beam according to a change in communication state.

Since characteristics of a wireless channel in high-frequency bands are similar to those of visible light, most of the transmission energy is concentrated on an LoS path. Hence, beamforming may be managed by utilizing sensing information obtained through sensors such as LiDAR, radar, and/or a camera instead of channel information measurements.

In accordance with an embodiment of the disclosure, a narrow, sharp beam may be generated by utilizing sensing information obtained through various types of sensors, and to this end, it is important to accurately measure angles (e.g., azimuth and elevation angles) and distances (e.g., depth information) for mobile objects such as a UE.

Physical characteristics obtained through various types of sensors such as a camera, LiDAR, radio detection and ranging (radar), and ultrasonic sensors may be converted into interpretable information, and interpretation and analysis of the sensing information may be performed through computer vision (CV) technology. Recently, with the advancement of deep learning, the performance of sensing information analysis using CV has been greatly improved, and an OD based on deep learning can classify objects in sensed data and determine the location of the classified objects.

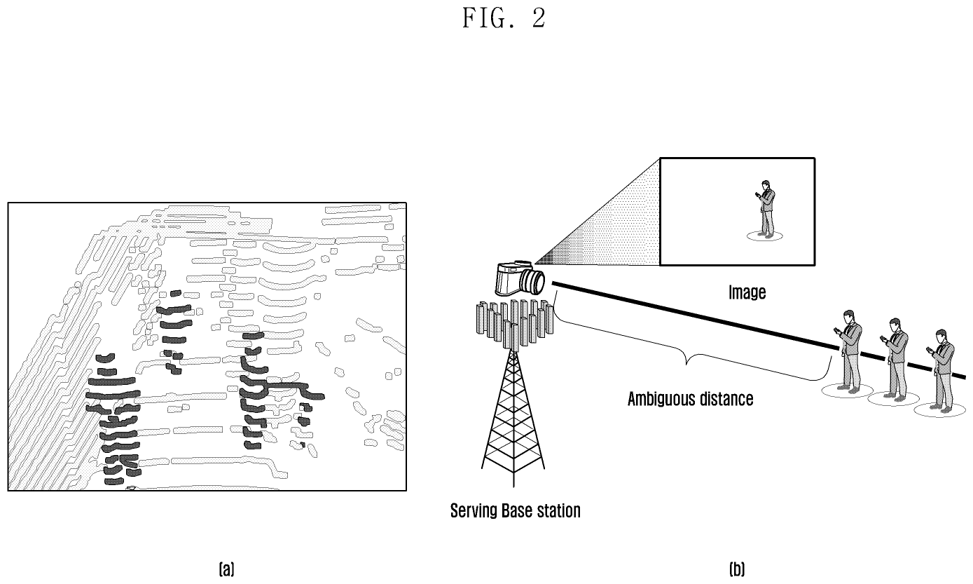

FIG. 2 illustrates a disadvantage of performing object detection through SMBM).

Referring to FIG. 2, part (a) is a drawing visualizing sensing data obtained through a LiDAR sensor, and part (b) is a drawing visualizing a method of performing object detection through an image captured by a camera installed in the serving BS. The sensing method through a LiDAR and the sensing method through a camera have their own disadvantages. For example, in the case of LiDAR, resolution is limited, making it difficult to identify the exact angle. In the case of a camera, sensing data lacks depth information, making it difficult to accurately determine the distance between the object included in the image captured by the camera and the camera. In particular, distance measurement using camera images may be difficult when the LoS is blocked by obstacles or when the weather is bad.

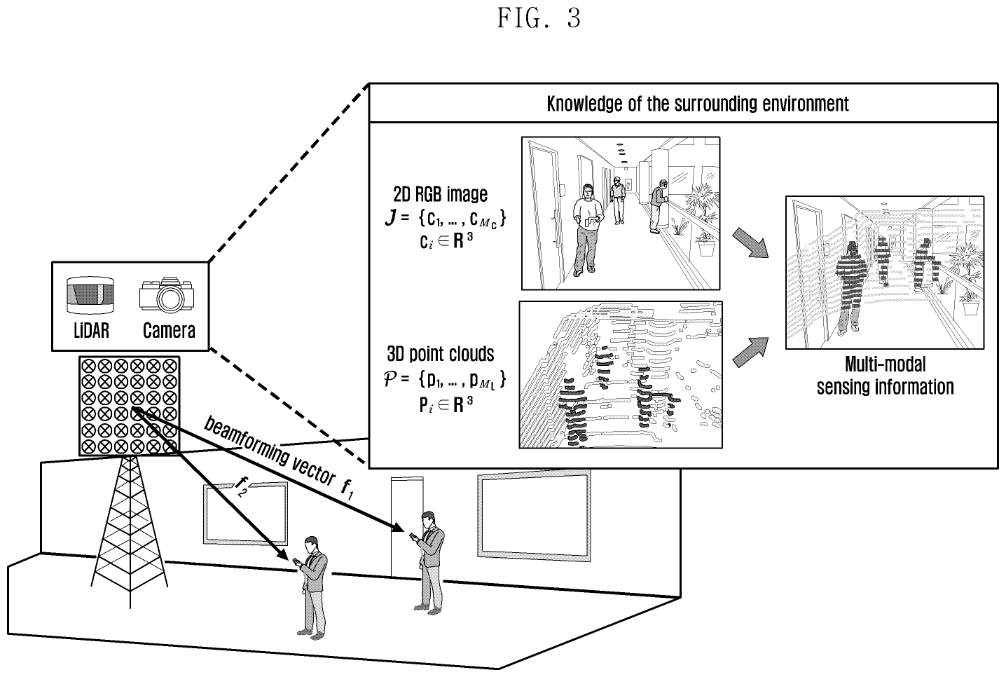

FIG. 3 illustrates a method utilizing MMBM according to an embodiment.

Referring to FIG. 3, based on images (e.g., two-dimensional RGB images) obtained through the camera and point cloud data obtained through the LiDAR, the BS may identify various objects around the BS and calculate location information of the identified objects. According to an embodiment, the BS may determine the direction (angle) and distance at which the preliminarily identified object is located in relation to the BS, and may determine the absolute location of the object with respect to the location information of the BS.

The example of FIG. 3 illustrates a situation in which the BS obtains multi-modal sensing information by combining 2D RGB images obtained through the camera and 3-dimensional (3D) cloud point data obtained through the LiDAR sensor, identifies objects located around the BS through this, and transmits a beam based on the location information of the object identified as a UE through beamforming. The BS may perform beamforming based on location information obtained through a CV-based OD, which may replace the operation of performing beamforming through quantized beam codewords in existing 5G NR.

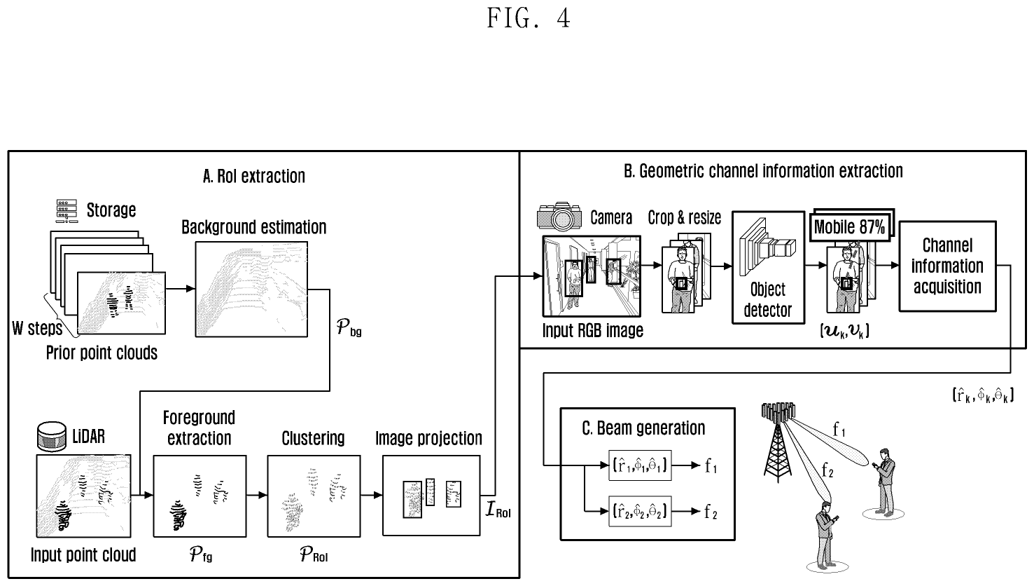

FIG. 4 illustrates a method utilizing MMBM according to an embodiment.

Referring to FIG. 4, the process of performing beamforming through MMBM may include three stages:
Stage 1: LRoI detection
Stage 2: Geometric channel information extraction based on CV
Stage 3: Beam generation based on geometric channel

In stage 1, a LiDAR sensor of a BS may be utilized to obtain sensing information about the vicinity of the LiDAR sensor, and a region (e.g., LRoI) for a mobile object may be extracted from the obtained information.

In stage 2, for the region extracted in stage 1, a UE included in the region may be extracted. That is, in stage 1, the region for a relatively large object may be extracted, and in stage 2, a relatively small object may be identified, and geometric information (3D location information) for the identified region may be calculated.

In stage 3, beam generation and beam transmission may be performed based on the UE's location calculated in stage 2.

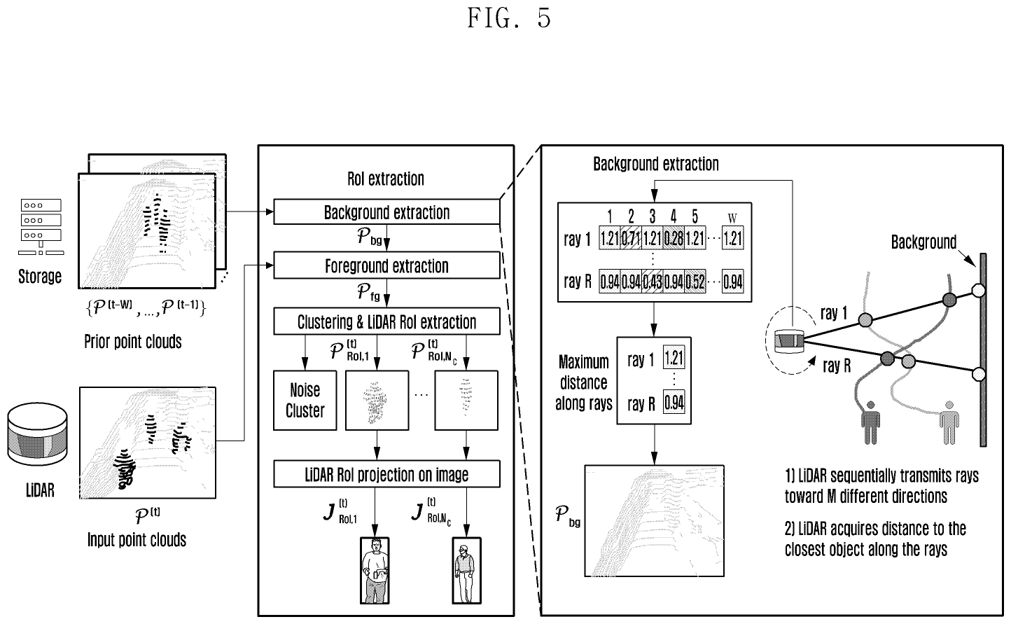

FIG. 5 illustrates a method for performing LRoI extraction according to an embodiment. For example, the LRoI extraction in FIG. 5 may correspond to stage 1 in FIG. 4.

Referring to FIG. 5, the BS may extract a region of interest (e.g., LRoI) from the data sensed through the LiDAR. When the data sensed as having similar values are classified into sets based on distance information of points sensed through the LiDAR, this LRoI extraction may be performed based on a set of classified points. For example, for the LRoI extraction process, prior point cloud data around the BS may be stored in a storage device inside the BS or in a storage device connected to the BS. The LiDAR sensor may sequentially emit light (rays) in different directions and detect the light reflected back from objects, and may measure the distance to a surrounding object based on the round-trip time and speed of light. When the BS obtains sensing information through the LiDAR sensor for beamforming, the obtained sensing information may be in the form of a point cloud, and the sensing information may be referred to as input point cloud data.

To extract the region of interest, the BS may first extract background information from previously collected prior point cloud data (background extraction). This background information is the background unrelated to a UE to be identified. In general, the background is relatively far from the BS and is fixed without moving, so the BS may determine fixed points, which are the farthest from the LiDAR sensor among the LiDAR rays indicating the same direction, as background.

With reference to FIG. 5, among the distance values obtained through light, high values may be determined as background, and low values may be determined as normal objects that are not background. The BS may cluster points with similar distance values into one set by determining that they represent the same object.

Thereafter, the BS may perform a foreground extraction step to remove the background from the input point cloud data. When the foreground extraction step is performed, the background unrelated to a UE may be removed from the input point cloud data, which can improve the accuracy of UE detection and reduce the computational complexity.

After the foreground extraction step is performed, the BS may perform clustering to classify the foreground points into a point cloud cluster and a noise cluster. Then, the BS may calculate the location of an image bounding box by projecting the point cloud cluster onto the 2D RGB image obtained through the camera. FIG. 5 illustrates a process in which point cloud sets for two people are clustered into point cloud clusters, and the point cloud clusters are separately projected onto the RGB image to determine bounding boxes for the two people.

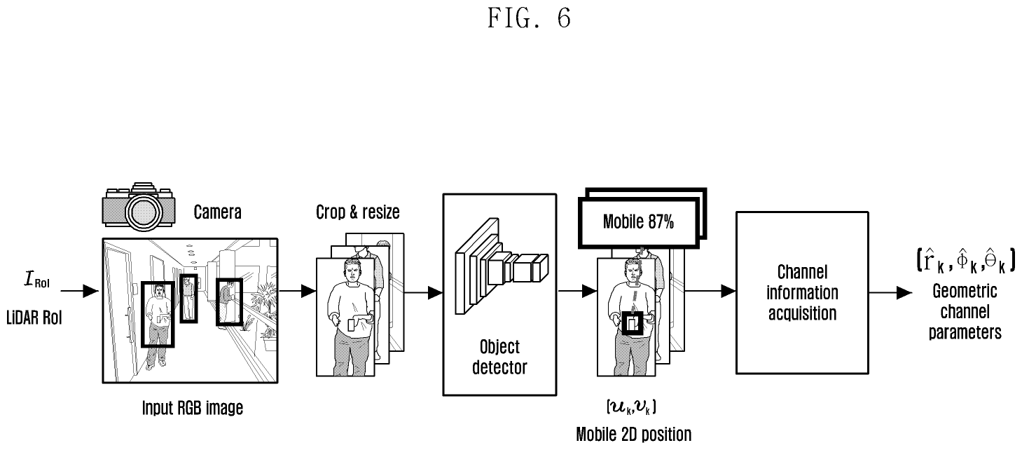

FIG. 6 illustrates a method for performing CV-based geometric channel information extraction according to an embodiment. For example, the CV-based geometric channel information extraction in FIG. 6 may correspond to stage 2 in FIG. 4.

Referring to FIG. 4, after projecting the point cloud detected through the LRoI onto the RGB image, the BS may perform cropping and resizing of the projected image. The images obtained through cropping and resizing like this may be used as input values for a deep learning-based OD.

In the CV-based geometric channel extraction step, the BS may identify a region representing a UE in the image obtained through the camera and extract geometric channel information for the UE based on this. To estimate the location of the UE, the BS may utilize an OD that estimates the location of the UE by incorporating deep learning (e.g., deep neural network). The BS may estimate the location of the UE by performing object detection on the image bounding boxes obtained through LRoI extraction described above in FIG. 5. The UE's final 3D location information may be calculated by combining the distance information obtained through the LiDAR points and the direction information obtained through the RGB image.

According to an embodiment, if the indices of bounding box images are l∈{1,2, . . . , N_{c}}, the number of estimated UEs in each bounding box image may be represented as Kₗ, and accordingly, the total number of estimated UEs may be represented as

$$K = {\sum }_{l = 1}^{{N}_{c}} {K}_{l} .$$

The location of UE k estimated through object detection may be represented as (uₖ, vₖ), where uₖ and vₖ may be values that represent the location of the k^{th} UE in the image in pixel units. The distance information from the BS to the UE may be extracted through the location of the LiDAR point with the shortest Euclidean distance from the UE location among the point clusters projected on the image obtained through the camera.

After completing the estimation of the UE's location (rₖ, uₖ, vₖ) based on the image coordinate system, to convert it into geometric channel information for the UE, the BS converts the UE's location on the image coordinate system into direction information from the BS toward the UE, e.g., as shown in Equation (1).

$$( {\hat{θ}}_{k} {\hat{ϕ}}_{k} ) = ( \frac{( {u}_{k} - {c}_{x} )}{{N}_{u}} {θ}_{FoV} , \frac{( {v}_{k} - {c}_{y} )}{{N}_{v}} {ϕ}_{Fov} ) \qquad ( 1 )$$

In Equation (1), (cₓ, c_{y}) may denote the center point of the image, (θ_{FoV}, ϕ_{FoV}) may denote the field of view of the camera, and (Nᵤ, Nᵥ) may denote the number of pixels of the image.

Thereafter, the BS may estimate the beamforming matrix F=[f₁, . . . , fₖ] that maximizes the sum rate of K UEs by utilizing the vector information derived based on Equation (1). The beamforming matrix F* may be calculated as shown in Equation (2) by utilizing the geometric channel information for the K UEs.

$${F}^{*} = {F}_{RF}^{*} {F}_{BB}^{*} = [ a ( {\hat{θ}}_{1} , {\hat{ϕ}}_{1} ) , , a ( {\hat{θ}}_{K} , {\hat{ϕ}}_{K} ) ] diag ( \sqrt{{p}_{1} ( \hat{{r}_{1}} )} , , \sqrt{{p}_{K} ( \hat{{r}_{K}} )} ) \qquad ( 2 )$$

In Equation (2), a(\hat{θ},\hat{ϕ}) may indicate the array steering vector, and pₖ(\hat{r}ₖ) may indicate the transmission power for UE k. Here, pₖ(\hat{r}ₖ) can be calculated as shown in Equation (3) below via a water-filling algorithm.

$${p}_{k} ( {r}_{k} ) = max ( 0 , \frac{1}{{v}_{k}} - \frac{{σ}_{n}^{2}}{N {\hat{α}}_{k} ( \hat{{r}_{k}} )} ) \qquad ( 3 )$$

In Equation (3), vₖ may denote the Lagrangian multiplier, and \hat{α}ₖ(\hat{r}ₖ) may denote the path gain estimated using the distance from the LiDAR sensor to the UE. The path gain may be calculated using a free space path loss model as shown in Equation (4) below.

$${\hat{α}}_{k} ( \hat{{r}_{k}} ) = {( \frac{c}{4 π {f}_{c} {\hat{r}}_{k}} )}^{2} \qquad ( 4 )$$

Thereafter, the BS may generate a beam and transmit the generated beam to the identified UE through stage 3 of FIG. 4.

According to an embodiment of the disclosure, the beamforming gain may be defined as a normalized correlation between the channel vector h and the beamforming vector w as shown in Equation (5) below.

$$G = \frac{\vert {h}^{H} w \vert}{‖ h ‖ ‖ w ‖} = \frac{1}{N} \vert {a}^{H} ( θ , ϕ ) a ( \hat{θ} , \hat{ϕ} ) \vert \qquad ( 5 )$$

According to an embodiment of the disclosure, the lower bound of the beamforming gain via MMBM may be defined as shown in Equation (6) below.

$$G \geq \frac{1}{N} \vert \frac{sin ( \frac{π {N}_{x} d}{2 r} ( \vert sin ϕ \vert + \vert cos ϕ cos θ \vert ) sin ( \frac{π {N}_{y} d}{2 r} ( \vert cos ϕ \vert + \vert cos ϕ sin θ \vert ) )}{sin ( \frac{π d}{2 r} ( \vert sin ϕ \vert + \vert cos ϕ cos θ \vert ) sin ( \frac{π d}{2 r} ( \vert cos ϕ \vert + \vert cos ϕ sin θ \vert ) )} \vert \qquad ( 6 )$$

In Equation (6), d may indicate the position error of the UE and r may indicate the communication distance.

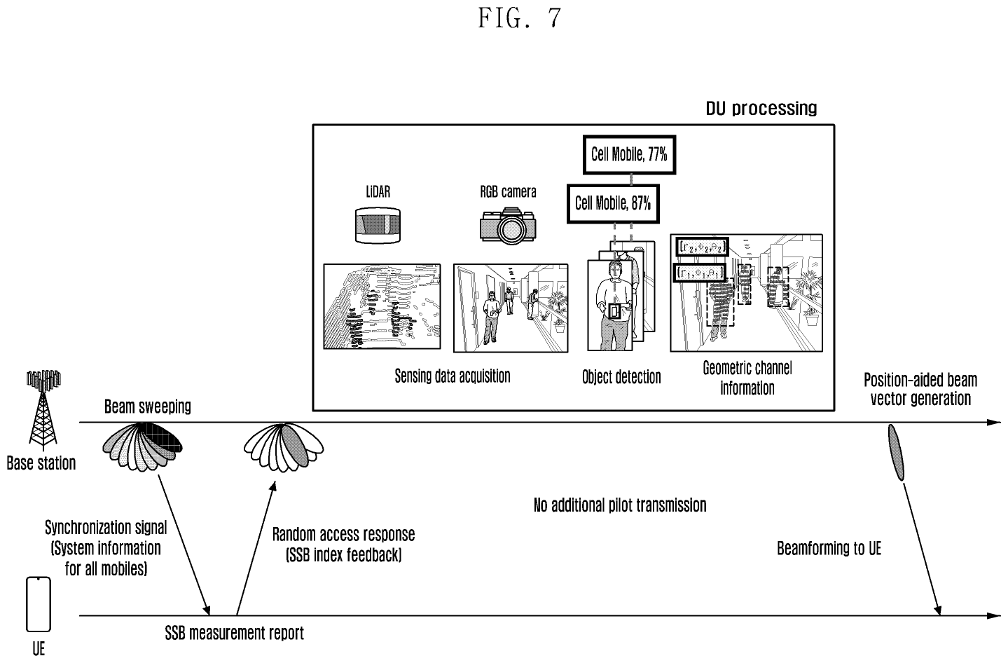

FIG. 7 illustrates a scenario for MMBM operations according to an embodiment.

Referring to FIG. 7, a BS may transmit a synchronization signal through beam sweeping. The synchronization signal may be broadcast in the form of an MIB and/or an SIB. The MIB may be transmitted through an SSB, and the SSB may include a primary synchronization signal (PSS), a secondary synchronization signal (SSS), and a physical broadcast channel (PBCH). The MIB may be delivered through the PBCH.

According to an embodiment, beam sweeping may be an operation in which the BS sequentially transmits beams in multiple directions according to specified beam directions and time intervals.

A UE may receive system information through a broadcast signal transmitted from the BS. The UE may receive SSBs through multiple beams transmitted by the BS through beam sweeping, and may perform signal measurements (e.g., RSRP, RS received quality (RSRQ), or SINR) for each SSB.

The UE may select at least one SSB with the best signal strength among the received SSBs, generate a measurement report for the same, and transmit the generated measurement report to the BS. The measurement reporting values may include information about an index to the SSB, signal strength and quality of the SSB, and measurement timing. The UE may connect to the BS through initial access in advance before performing measurement reporting, and then transmit the measurement report on the SSB to the BS. For example, the measurement report on the SSB may be transmitted by being included in a random access response (RAR) transmitted by the UE to the BS during the random access process.

Thereafter, the BS may obtain sensing data through the LiDAR sensor and RGB camera, perform object detection based on the obtained data, and extract geometric location information (e.g., 3D location information including distance, azimuth, and elevation angle) of the detected object (e.g., an MMBM execution step). According to an embodiment, this operation of the BS may be performed by a DU of the BS.

The BS may perform beamforming based on the UE location information estimated/calculated in the MMBM stage. In the beamforming stage, scheduling for frequency and time may be performed. That is, the BS may determine the direction of the beam to be transmitted for beamforming, and determine the timing and frequency band for the beam to be transmitted.

According to an embodiment, to separately identify surrounding UEs, the BS may assign a radio identification number (cell-radio network temporary identifier (C-RNTI)) to each UE. That is, the BS may match C-RNTIs with the locations of the UEs detected through MMBM, generate narrow directional beams, and transmit them to the locations of the detected UEs. Accordingly, if the location of the UE is identified through MMBM and beamforming is performed based on the identified location, the beam training overhead and power consumption can be reduced because the complex beam sweeping and selection process is unnecessary.

In addition, according to an embodiment of the disclosure, since a portion where an object is expected to be present is extracted as a region of interest by using a LiDAR, and object detection is performed only for the corresponding narrow region, the computational complexity can be reduced compared to performing image processing on the entire RGB image.

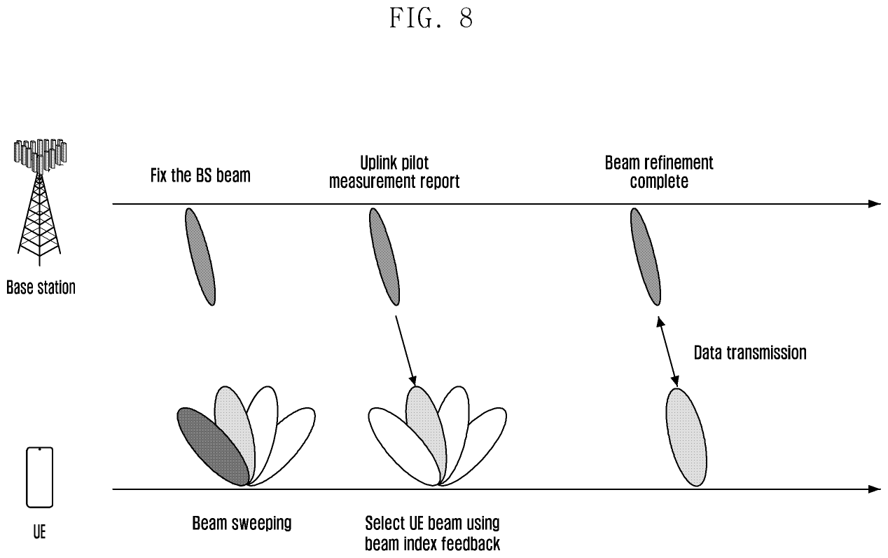

FIG. 8 illustrates a method for performing UE-side beamforming according to an embodiment.

Referring to FIG. 8, when codebook-based beamforming reception is performed on a UE side, a BS may fix the transmission beam determined through MMBM, and the UE may sequentially adjust the direction of the beam through beam sweeping. When the UE transmits beams in various directions, the BS may measure the reception RSRP of UL pilot signals transmitted through the beams and transmit index information of the UE beam with the highest reception RSRP to the UE. Thereafter, the UE may select the optimal beam by utilizing the beam index information received from the BS.

The operation illustrated in FIG. 8 may be referred to as receiver-side beam adjustment (or beam refinement for receiver), and may be optionally performed after the MMBM operation.

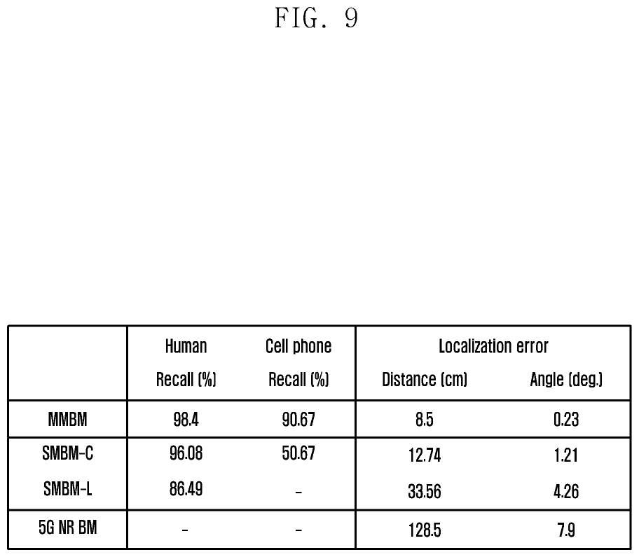

FIG. 9 illustrates experiment results according to an embodiment.

Referring to FIG. 9, the performance when MMBM is applied is compared with the cases of applying SMBM-camera (C) (i.e., SMBM using only a camera sensor), SMBM-LiDAR (L) (i.e., SMBM using only a LiDAR sensor), and 5G NR BM.

FIG. 9 illustrates a human recall percentage for persons located around a BS, a cell phone recall percentage, and a localization error classified by distance and angle.

AS illustrated by the results in FIG. 9, MMBM shows a 40% improvement in UE (cell phone) recall compared to SMBM-C utilizing only a camera. As such, it appears that SMBM-L utilizing only a LiDAR did not properly recognize cell phones, which may be due to the characteristic that the LiDAR's resolution is not suitable for detecting small objects.

For the localization error, MMBM exhibits a lower error level in terms of distance and angle compared to SMBM-C and SMBM-L, and also exhibits a significantly lower error level compared to the 5G NR BM.

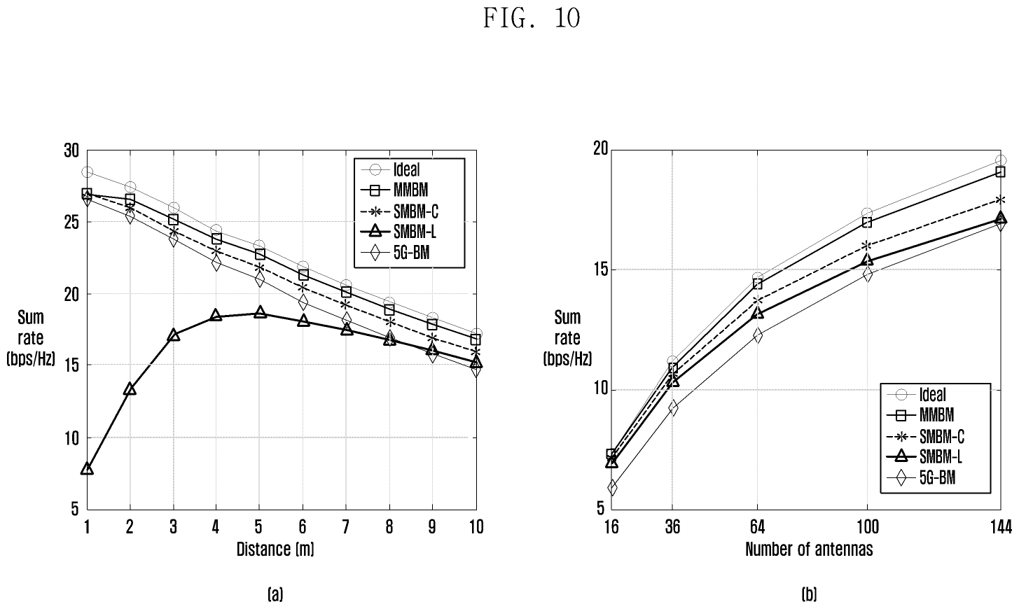

FIG. 10 illustrates experiment results according to an embodiment.

Referring to FIG. 10, as shown in graph (a), the sum rates for the situations where various beamforming schemes are applied are plotted in bps/Hz units in correspondence to the distance between the BS and the UE. The sum rate is the total data transmission rate achieved in a given bandwidth, and is an indicator used to evaluate the efficiency of a communication system. Specifically, graph (a) shows that the sum rate when beamforming is performed according to MMBM is most similar to that of when beamforming is performed in an ideal way, and that it is highest compared to the sum rates for SMBM-C, SMBM-L, and 5G NR BM.

As shown in graph (b), the sum rates for the situations where various beamforming schemes are applied are plotted in bps/Hz units in correspondence to the number of antennas. Graph (b) shows that the sum rate when beamforming is performed according to MMBM is most similar to that of when beamforming is performed in an ideal way, and that it is highest compared to the sum rates for SMBM-C, SMBM-L, and 5G NR BM.

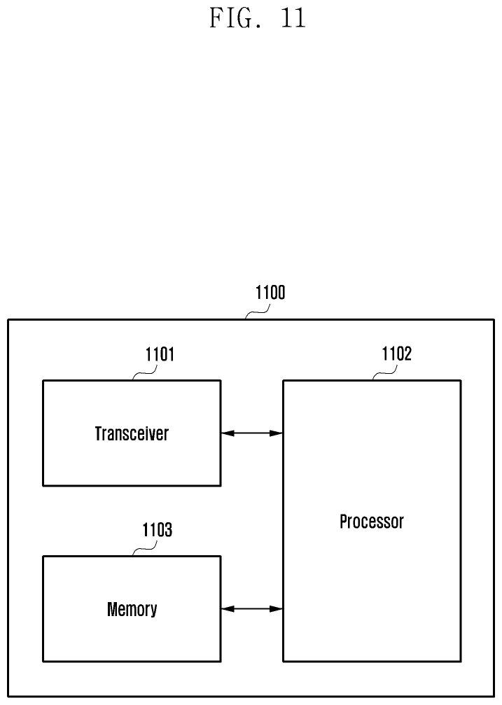

FIG. 11 illustrates a terminal according to an embodiment.

Referring to FIG. 11, the terminal 1100 is an electronic device capable of wireless communication, and may include a UE, a portable phone, a smartphone, a tablet, an Internet of things (IoT) device, etc., having various form factors, and may perform wireless communication with a BS through a wireless channel.

The UE 1100 includes a transceiver 1101, a processor 1102, and a memory 1103. However, components of the UE 1100 are not limited to the exemplary components illustrated in FIG. 11. For example, the UE 1100 may include additional components, or some of the illustrated components may be omitted. Further, in some embodiments, any combination of the transceiver 1101, the processor 1102, or the memory 1103 may be integrated in the form of one component.

The transceiver 1101, the processor 1102, and the memory 1103 of the UE 1100 may operate according to at least one or a combination of methods corresponding to the embodiments described above.

The transceiver 1101 may be a communication circuit or communication circuitry that allows the UE 1100 to perform wireless communication with a node or an entity of a network. For example, the transceiver 1101 may allow the UE 1100 to transmit or receive a signal to or from a BS through cellular communication, or to transmit or receive a signal to or from another UE through cellular communication. For example, the transceiver 1101 may support at least one of various cellular communication technologies including 3rd generation (3G), 4th generation (4G), LTE, 5G NR, 6G, etc., and various cellular wireless communication technologies supported by the transceiver 1101 may include all subsequent generations of evolved wireless communications.

The UE 1100 may also include a plurality of transceivers. For example, in the case of supporting evolved-universal terrestrial radio access-NR (E-UTRA-NR) dual connectivity (EN-DC), the UE 1100 may include a first transceiver supporting the 4G LTE wireless communication and a second transceiver supporting the 5G NR wireless communication.

According to another embodiment, in the case of supporting NR-dual connectivity (NR-DC), the UE 1100 may include a plurality of transceivers supporting the 5G NR wireless communication.

According to another embodiment, in the case of supporting near field wireless communication, the UE 1100 may separately include a transceiver supporting at least one standard in the group of wireless communication protocol standards as defined in the protocol standards for Bluetooth®, wireless local area network (WLAN) network (including institute of electrical and electronics engineers (IEEE) 802.11-2016 standard or its amendments, e.g., 802.11ah, 802.11ad, 802.11ay, 802.11ax, 802.11az, 802.11ba, and 802.11be, without being limited thereto).

According to an embodiment, the transceiver 1101 may include various circuit structures used to transmit or receive signals to or from a BS through a wireless channel. The signals may include control information and data. For example, the transceiver 1101 may include an RF transmitter for up-converting and amplifying the frequency of a transmitted signal and an RF receiver for low-noise-amplifying a received signal and down-converting the frequency thereof. The transceiver 1101 may output a signal received through a wireless channel to the processor 1102 and may transmit, through a wireless channel, a signal output from the processor 1102.

The processor 1102 may control general operations of the UE 1100 according to any of the embodiments of the disclosure. The processor 1102 may be implemented by one or more IC chips and may execute various data processing. The processor 1102 may include at least one electric circuit, and may execute instructions (or a program, codes, data, etc.) stored in the memory 1103, individually, collectively or in any combination thereof. Further, the processor 1102 may include a single-core processor or multi-core processor, and may include a processor assembly including a plurality of processing circuits (circuitry) according to a specific implementation scheme.

The processor 1102 may be electrically, operatively, or communicatively coupled to the transceiver 1101 to control the transceiver 1101.

The processor 1102 may include at least one processor (or processing circuitry), and the at least one processor may perform the following operations individually, collectively or in any combination thereof. For example, the processor 1102 may include a CP configured to control communication operations and an AP configured to control execution of an upper layer (e.g., an application layer). At least a part of the processor 1102 may be included in one chip and the other part of the processor 1102 may be included in another chip. Alternatively, the processor 1102 may be included in another component, e.g., the transceiver 1101 or the memory 1103.

The processor 1102 may perform or control or cause an operation of the UE 1100 for executing at least one or a combination of methods according to embodiments of the disclosure. For example, the processor 1102 may control operations of the UE 1100 for processing a DL signal received from a BS or generating and transmitting a UL signal to a BS. To this end, the processor 1102 may execute a computer program, codes, or instructions stored in the memory 1103, so as to control other components of the UE 1100 to allow for execution of various operations.

The memory 1103 may correspond to a hardware storage device capable of temporarily or permanently storing information and may include one or more storage media. For example, the memory 1103 may include a memory assembly including one or more storage media. For example, the one or more storage media may include permanent memory, such as a hard drive, flash memory, or ROM, semipermanent memory, such as RAM, cache memory, or a combination thereof.

The memory 1103 may be electrically, operatively, or communicatively coupled to the processor 1102 and may be accessed by the processor 1102.

The memory 1103 may store a computer program, codes, or instructions executable by the processor 1102. A computer program, codes, or instructions executable by the processor 1102 may be either stored in a single memory device or separated and distributively stored in two or more memory devices. By executing the instructions stored in the memory 1103, the processor 1102 may perform various functions according to an embodiment of the disclosure.

According to an embodiment of the disclosure, operations of the UE 1100 may be caused to be performed based on execution of instructions (or a computer program or codes) stored in the memory 1103 by at least one processor (or processing circuitry) configured to execute the same individually, collectively, or in any combination thereof, based on processing circuitry that is not configured to execute instructions, and/or based on components of processing circuitry that is not configured to execute instructions.

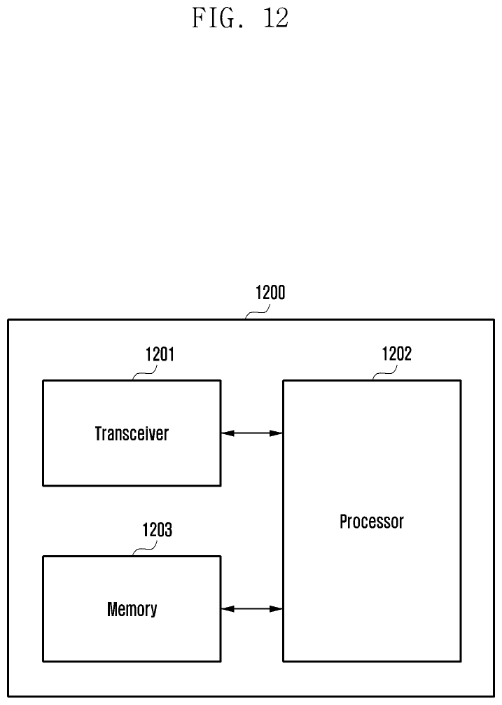

FIG. 12 illustrates a BS according to an embodiment.

Referring to FIG. 1, the BS 1200 may perform wireless communication with at least one UE located within the area of the BS 1200 through a wireless channel.

The BS 1200 includes a transceiver 1201, a processor 1202, and a memory 1203. However, components of the BS 1200 are not limited to the exemplary components illustrated in FIG. 12. In another embodiment, the BS 1200 may further include additional components, or some of the illustrated components may be omitted. Further, in some embodiments, any combination of the transceiver 1201, the processor 1202, or the memory 1203 may be integrated in the form of one component.

The transceiver 1201, the processor 1202, and the memory 1203 of the BS 1200 may operate according to at least one or a combination of methods corresponding to the above-described embodiments.

The transceiver 1201 may be a communication circuit or communication circuitry that allows the BS 1200 to perform wireless communication with a node or an entity of a network. For example, the transceiver 1201 may enable the BS 1200 to transmit or receive a signal to or from the UE 1100 through cellular communication, or to transmit or receive a signal to or from another network entity through wireless communication. For example, the transceiver 1201 may support various cellular communication technologies including 3G, 4G, LTE, 5G NR, 6G, etc., and various cellular wireless communication technologies supported by the transceiver 1201 may include all subsequent generations of evolved wireless communications.

According to an embodiment, the transceiver 1201 may include various circuit structures used to transmit or receive signals to or from a UE through a wireless channel. The signals may include control information and data. For example, the transceiver 1201 may include an RF transmitter for up-converting and amplifying the frequency of a transmitted signal and an RF receiver for low-noise-amplifying a received signal and down-converting the frequency thereof. The transceiver 1201 may output a signal received through a wireless channel to the processor 1202 and may transmit, through a wireless channel, a signal output from the processor 1202.

According to an embodiment, the BS 1200 may perform communication with a node or an entity of a network through wired or wireless communication. For example, the BS 1200 may perform wired or wireless communication with an adjacent BS, or a node or an entity of a core network through a backhaul network. Although not illustrated in FIG. 12, when the BS 1200 performs wired communication, the BS 1200 may further include a separate network interface for wired communication in addition to the transceiver 1201. The network interface may be referred to as network interface circuitry or communication interface circuitry.

The processor 1202 may control general operations of the BS 1200 according to any of the embodiments of the disclosure. The processor 1202 may be implemented by one or more IC chips and may execute various data processing. The processor 1202 may include at least one electric circuit, and may execute instructions (or a program, codes, data, etc.) stored in the memory 1203, individually, collectively or in any combination thereof. Further, the processor 1202 may include a single-core processor or multi-core processor, and may include a processor assembly including a plurality of processing circuits (circuitry) according to a specific implementation scheme.

The processor 1202 may be electrically, operatively, or communicatively coupled to the transceiver 1201 to control the transceiver 1201.

The processor 1202 may include at least one processor (or processing circuitry), and the at least one processor may perform the following operations individually, collectively or in any combination thereof. At least a part of the processor 1202 may be included in one chip and the other part of the processor 1202 may be included in another chip. Alternatively, the processor 1202 may be included in another component, e.g., the transceiver 1201 or the memory 1203.

The processor 1202 may perform or control or cause an operation of the BS 1200 for executing at least one or a combination of methods according to embodiments of the disclosure. For example, the processor 1202 may control operations of the BS 1200 for generating and transmitting a DL signal to a UE or processing a UL signal received from a UE. Otherwise, the BS 1200 may transmit or receive a signal to or from a neighboring BS, transfer a signal received from a UE to an upper node of the network, or transmit a signal transferred from an upper node of the network to a UE. To this end, the processor 1202 may execute a computer program, codes, or instructions stored in the memory 1203, so as to control other components of the BS 1200 to enable execution of various operations.

The memory 1203 may correspond to a hardware storage device capable of temporarily or permanently storing information and may include one or more storage media. For example, the memory 1203 may include a memory assembly including one or more storage media. For example, the one or more storage media may include permanent memory, such as a hard drive, flash memory, or ROM, semipermanent memory, such as RAM, cache memory, or a combination thereof.

The memory 1203 may be electrically, operatively, or communicatively coupled to the processor 1202 and may be accessed by the processor 1202.

The memory 1203 may store a computer program, codes, or instructions executable by the processor 1202. According to an embodiment, a computer program, codes, or instructions executable by the processor 1202 may be either stored in a single memory device or separated and distributively stored in two or more memory devices. By executing the instructions stored in the memory 1203, the processor 1202 may perform various functions according to an embodiment of the disclosure.

According to an embodiment, operations of the BS 1200 may be caused to be performed based on execution of instructions (or a computer program or codes) stored in the memory 1203 by at least one processor (or processing circuitry) configured to execute the same individually, collectively, or in any combination thereof, based on processing circuitry that is not configured to execute instructions, and/or based on components of processing circuitry that is not configured to execute instructions.

The UE or the BS may perform various communication procedures related to the control plane or the user plane by cooperating with one or more network entities based on wireless communication. For example, the UE may communicate with network entity such as an access and mobility management function (AMF) or a session management function (SMF) via the BS, or the BS may perform at least one communication procedure by directly transmitting and receiving signals to/from, or relaying signals between, the network entities

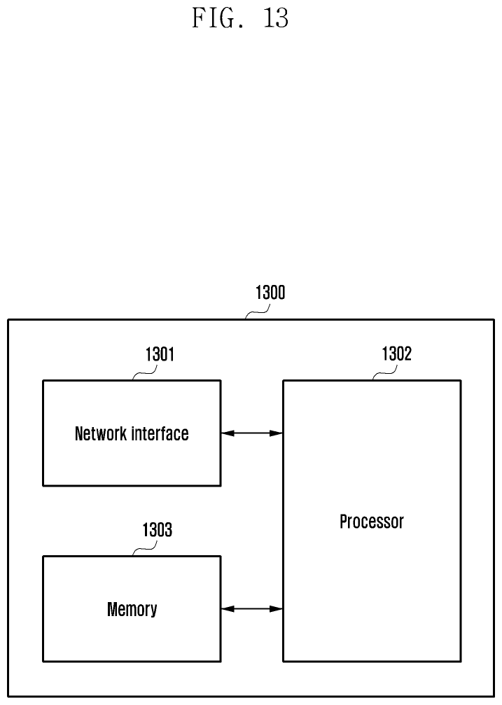

FIG. 13 illustrates a network entity according to an embodiment.

Referring to FIG. 13, the network entity 1300 may include an entity (e.g., an apparatus, a device, a server, etc.) that performs one or more network functions (NFs) or a part of an NF included in a core network (e.g., a 5G core (5GC)) in a communication system. In this case, multiple NFs may be implemented within a single network entity, or a single NF may be distributed and implemented across a plurality of network entities. In addition, when an NF is implemented within the network entity, the NF may be implemented in the form of software, and in such a case, a program for operating the NF may be stored in memory of the network entity 1300.

A single NF may be implemented by one or more instances, which may be deployed on the same network entity or distributed across multiple network entities to operate. The instance may be a software unit that logically executes a specific NF, and may be implemented in a form that is decoupled from physical hardware resources. Further, one or more NFs may be implemented in the form of one network slice to operate to satisfy specifications required by a particular service.

The NF may include at least one of an AMF, an SMF, a local SMF (L-SMF), a user plane function (UPF), a local UPF (L-UPF), a policy control function (PCF), a unified data management (UDM), a unified data repository (UDR), a network exposure function (NEF), a network repository function (NRF), an application function (AF), a network slice selection function (NSSF), a network data analytics function (NWDAF), a network slice admission control function (NSACF), an authentication server function (AUSF), or a data network (DN).

The network entity 1300 includes a network interface 1301, a processor 1302, and a memory 1303. However, components of the network entity 1300 are not limited to the exemplary components illustrated in FIG. 13. In another embodiment, the network entity 1300 may include additional components, or some of the illustrated components may be omitted. Further, in an embodiment, the network interface 1301, the processor 1302, or the memory 1303 may be integrated in the form of one component.

As described above, an NF may be implemented in the form of a physical device such as the network entity 1300, or may be virtualized and executed in the form of an instance. When implemented as an instance, the NF may not necessarily include physical components as illustrated in FIG. 13. In such a case, the instance may be logically represented as comprising one or more logical functional elements.

The network interface 1301, the processor 1302, and the memory 1303 of the network entity 1300 may operate according to at least one or a combination of methods corresponding to the above-described embodiments.

The network interface 1301 is a collective term for a transmitter part of the network entity 1300 and a receiver part of the network entity 1300, and may be a communication circuit for transmitting or receiving a signal to or from a UE, a BS, or another network entity. Here, the communication circuit may include both a communication circuit for wireless communication and a communication circuit for a wired communication. For example, the network interface 1301 may include a circuit, logic, hardware, etc., configured to exchange a control plane message or a user plane message with a UE, a BS, or other core network entities through wireless communication or wired communication. The network interface 1301 may operate using various protocols (e.g., a NAS protocol). The network interface 1301 may also be referred to, for convenience of description or depending on implementation, as communication circuitry, network interface circuitry, or a communication interface circuitry.

The processor 1302 may control general operations of the network entity 1300 according to embodiments of the disclosure. The processor 1302 may be implemented by one or more IC chips and may execute various data processing. The processor 1302 may include at least one electric circuit, and may execute instructions (or a program, codes, data, etc.) stored in the memory 1303, individually, collectively or in any combination thereof. Further, the processor 1302 may include a single-core processor or multi-core processor, and may include a processor assembly including a plurality of processing circuits (circuitry) according to a specific implementation scheme. Further, according to another embodiment, in a case where an NF is implemented in the form of an instance, the NF may be not necessarily configured by physical hardware.

According to an embodiment, the processor 1302 may be electrically, operatively, or communicatively coupled to the network interface 1301 to control the network interface 1301.

The processor 1302 may include at least one processor (or processing circuitry), and the at least one processor may perform the following operations individually, collectively or in any combination thereof. In a specific embodiment, at least a part of the processor 1302 may be included in one chip and the other part of the processor 1302 may be included in another chip. Alternatively, the processor 1302 may be included in another component, e.g., the network interface 1301 or the memory 1303.

The processor 1302 may perform or control or cause an operation of the network entity 1300 for executing at least one or a combination of methods according to embodiments of the disclosure. For example, the processor 1302 may control operations of the network entity 1300 for exchanging a control plane message or a user plane message with a UE, a BS, or other core network entities through wireless or wired communication, using various protocols (e.g., NAS protocol). To this end, the processor 1302 may execute a computer program, codes, or instructions stored in the memory 1303, so as to control other components of the network entity 1300 to enable execution of various operations.

The memory 1303 corresponds to a hardware storage device capable of temporarily or permanently storing information and may include one or more storage media. For example, the memory 1303 may include a memory assembly including one or more storage media. For example, the one or more storage media may include permanent memory, such as a hard drive, flash memory, or ROM, semipermanent memory, such as RAM, cache memory, or a combination thereof.

The memory 1303 may be electrically, operatively, or communicatively coupled to the processor 1302 and may be accessed by the processor 1302.

The memory 1303 may store a computer program, codes, or instructions executable by the processor 1302. According to an embodiment, a computer program, codes, or instructions executable by the processor 1302 may be either stored in a single memory device or separated and distributively stored in two or more memory devices. By executing the instructions stored in the memory 1303, the processor 1302 may perform various functions according to an embodiment of the disclosure.

According to an embodiment of the disclosure, operations of the network entity 1300 may be caused to be performed based on execution of instructions (or a computer program or codes) stored in the memory 1303 by at least one processor (or processing circuitry) configured to execute the same individually, collectively, or in any combination thereof, based on processing circuitry that is not configured to execute instructions, and/or based on components of processing circuitry that is not configured to execute instructions.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a base station (BS) in a wireless communication system, the method comprising:
obtaining cloud point information through a light detection and ranging (LiDAR) sensor;
obtaining image information through a camera;
extracting a region of interest based on the cloud point information;
projecting the region of interest onto the image information;
identifying an image of a terminal within the region of interest projected onto the image information;
calculating three-dimensional location information for the terminal; and
performing beamforming based on the three-dimensional location information.

2. The method of claim 1, wherein calculating the three-dimensional location information for the terminal is performed based on the cloud point information and the image information.

3. The method of claim 2, wherein calculating the three-dimensional location information for the terminal is performed based on a location of the terminal in the image and a location of a cloud point with a shortest distance from the LiDAR sensor in the image among the cloud points projected onto the terminal image.

4. The method of claim 1, wherein extracting the region of interest based on the cloud point information comprises performing foreground extraction by removing background information extracted based on previously collected prior point cloud information from the cloud point information.

5. The method of claim 4, further comprising classifying cloud points obtained through foreground extraction into a point cloud cluster or a noise cluster.

6. The method of claim 4, wherein the background information is determined based on a point with the largest distance value from the LiDAR sensor in the previously collected prior point cloud information.

7. The method of claim 1, wherein performing the beamforming comprises calculating a beamforming matrix for the at least one terminal, and
wherein elements of the beamforming matrix are calculated according to a steering vector extracted based on the image information and transmission power to the terminal.

8. The method of claim 1, further comprising:
receiving uplink (UL) pilot signals from the terminal; and
transmitting, to the terminal, beam index information of a UL pilot signal having a highest reference signal received power (RSRP) among the UL pilot signals.

9. A base station (BS), comprising:
a transceiver; and
a controller configured to:
obtain cloud point information through a light detection and ranging (LiDAR) sensor,
obtain image information through a camera,
extract a region of interest based on the cloud point information,
project the region of interest onto the image information,
identify an image of a terminal within the region of interest projected onto the image information,
calculate three-dimensional location information for the terminal, and
perform beamforming based on the three-dimensional location information.

10. The BS of claim 9, wherein the three-dimensional location information for the terminal is calculated based on the cloud point information and the image information.

11. The BS of claim 10, wherein the three-dimensional location information for the terminal is calculated based on a location of the terminal in the image and a location of a cloud point with a shortest distance from the LiDAR sensor in the image among the cloud points projected onto the terminal image.

12. The BS of claim 9, wherein, to extract the region of interest based on the cloud point information, the controller is further configured to perform foreground extraction by removing background information extracted based on previously collected prior point cloud information from the cloud point information.

13. The BS of claim 12, wherein the controller is further configured to classify cloud points obtained through foreground extraction into a point cloud cluster or a noise cluster.

14. The BS of claim 12, wherein the controller is further configured to determine the background information based on a point with a largest distance value from the LiDAR sensor in the previously collected prior point cloud information.

15. The BS of claim 9, wherein the controller is further configured to calculate a beamforming matrix for the at least one terminal, and
wherein elements of the beamforming matrix are calculated according to a steering vector extracted based on the image information and transmission power to the terminal.

16. The BS of claim 9, wherein the controller is further configured to:
receive uplink (UL) pilot signals from the terminal, and
transmit, to the terminal, beam index information of a UL pilot signal having a highest reference signal received power (RSRP) among the UL pilot signals.
